(19) United States
(12) Patent Application Publication
(10) Pub. No.: US 2008/0310166 A1
(43) Pub. Date: Dec. 18, 2008

(54) Toroidal Lens

(76) Inventors: Jeyachandrabose Chinniah, Belleville, MI (US); Edwin Mitchell Sayers, Saline, MI (US); Christopher L. Eichelberger, Livonia, MI (US); Kyle Lucas, Livonia, MI (US)

Correspondence Address: VISTEON/BRINKS HOFER GILSON & LIONE, 524 South Main Street, Suite 200, Ann Arbor, MI, 48104, US

(21) Appl. No.: 11/763,228

(22) Filed: Jun. 14, 2007

(51) Int. Cl. F21V 5/04

(52) U.S. Cl. 362/268; 362/335

(57) ABSTRACT

A lens, suitable for automotive applications, for use with a light source is provided. The lens has a main body defining a cross sectional shape with a curved side and a straight side. The main body is formed by rotating the cross sectional shape about an axis of revolution located outside the main body. The axis of revolution is parallel to the straight side of the cross section and passes through a focal point defined by the curved side.

### BACKGROUND

1. Field of the Invention

The present invention generally relates to lenses for use with light sources. More specifically, the invention relates to a light assembly having a lens and a light source, particularly such assemblies that may be utilized in automotive applications.

2. Description of Related Art

Light-emitting diode (LED) lamps are increasingly finding applications in the automotive industry. Initially used as high-mounted stop lamps, LED applications today include virtually all types of signal lamps, such as turn, stop, park, and daytime running lights (DRL), as well as low/high beam headlamps and fog lamps. Commonly used optic elements for these applications include stand-alone reflectors, reflectors with spreading lens optics, projector lamps with horizontally positioned reflective shields together with standard condenser lenses, and directly projected LED dies using standard or free form condenser lenses. Recently, compound parabolic concentrator lenses (CPCs) and near field cone optic lenses (NFLs) have also been developed for use in headlamps and fog lamps.

For many exterior automotive lighting functions, it is desired that the beam pattern be wider in the horizontal direction than in the vertical direction. For forward lighting applications, governmental and consumer standards dictate tight constraints on the vertical beam pattern. Collimating lenses, such as standard or free form condenser lenses, have been used to control the vertical beam pattern. However, such lenses also have the effect of collimating light rays in the horizontal direction, which is generally undesirable. Horizontal beam spreading has been accomplished in the above-mentioned lenses through the use of a reflector or other optical element placed between the light source and the lens.

Styling is another consideration in designing a light assembly. Unfortunately, styling is commonly sacrificed to achieve the desired functionality in collimating lenses. One reason for this is that condenser lenses often appear similar, even when the size and shape (circular or rectangular) are varied.

In view of the above, it is apparent that there exists a need for a lens that collimates light rays in a vertical direction without collimating the light rays in a horizontal direction. Furthermore, there exists a need for a lens having this type of function while still allowing for styling variations.

### SUMMARY

In satisfying the above need, as well as overcoming the enumerated drawbacks and other limitations of the related art, the present invention provides a lens for use with a light source that is configured to collimate light rays in a single direction, while refraining from collimating rays in other directions. The lens comprises a main body having an axis of revolution located outside the main body. In cross-section, the main body has a curved side and a straight side. The curved side has a focal point through which the axis of revolution of the main body passes. The axis of revolution is also parallel to the straight side of the cross-section.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1A is a perspective view of a known standard condenser lens;

FIG. 1B is a cross-sectional view of the standard condenser lens of FIG. 1A, having an axis of revolution passing therethrough;

FIG. 1C is a perspective view of the standard condenser lens of FIGS. 1A and 1B, having light rays being directed therethrough;

FIG. 1D is a schematic side view of the standard condenser lens of FIGS. 1A-1C, showing light rays directed therethrough;

FIG. 1E is a schematic plan view of the standard condenser lens of FIGS. 1A-1D, showing light rays directed therethrough;

FIG. 2 is a schematic side view of a known free form condenser lens, illustrating light rays being directed therethrough;

FIG. 3A is a cross-sectional view of a lens embodying the principles of the present invention, having an axis of revolution located outside of the lens;

FIG. 3B is a perspective view of the lens of FIG. 3A;

FIG. 3C is a rear view of the lens of FIGS. 3A and 3B;

FIG. 3D is a schematic plan view of a cross section of the lens of FIGS. 3A-3C, showing light rays being directed therethrough;

FIG. 3E is a schematic side view of a cross section of the lens of FIGS. 3A-3D, showing light rays being directed therethrough;

FIG. 4 is a schematic plan view of another lens embodying the principles of the present invention; and

FIG. 5 is a perspective view of yet another lens embodying the principles of the present invention.

### DETAILED DESCRIPTION

The present invention provides a lens having a unique shape that collimates light rays in one direction, while maintaining the original spread of the light rays along another direction. This invention will have utility in vehicle headlamp lenses, where it is desirable to vertically collimate light rays while generally allowing the horizontal spreading of the light rays. It is contemplated that the present invention will also have utility in many other applications, without falling beyond the spirit and scope of the present invention.

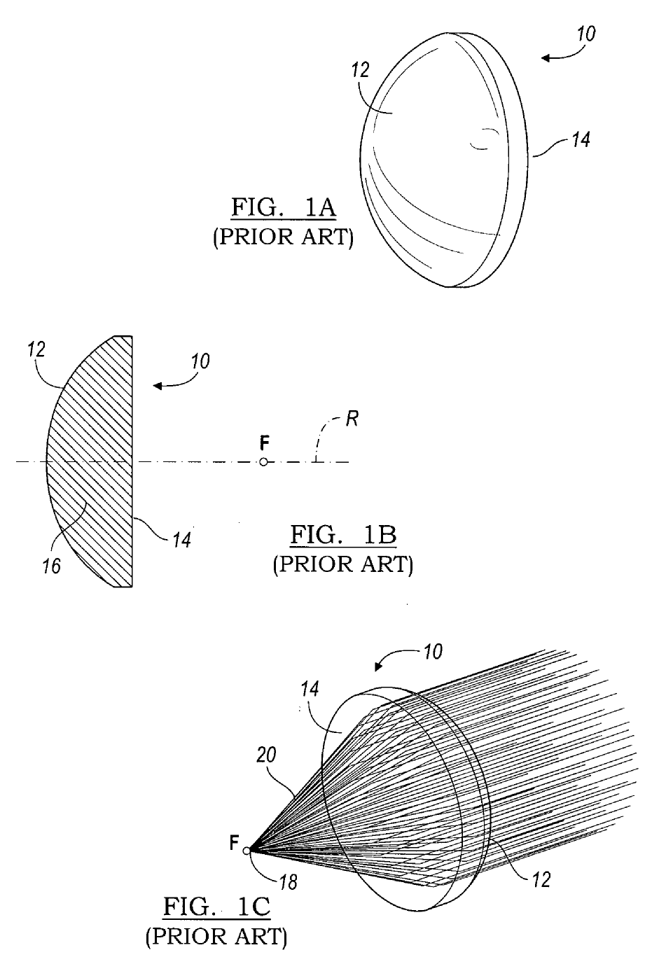

Referring now to FIGS. 1A-1E, a known lens 10 is illustrated therein. The lens 10 is a standard condenser lens as is known in the art. The standard condenser lens 10 has a curved light emitting face or side 12 that is disposed opposite of a flat light receiving face or side 14. The lens 10 is preferably a solid body 16 in its cross section and is preferably formed of optical-grade plastic or glass. As seen in FIG. 1B, the lens 10 is symmetrical about the axis of revolution R.

When a light source 18 is placed at the focal point F of the lens 10, the lens 10 collimates or nearly collimates all of the light rays 20 emanating from the light source 18. Because the lens 10 is symmetrical about the axis of revolution R, the lens 10 collimates light rays 20 both vertically and horizontally. In fact, the lens 10 collimates light rays 20 through all 360 degrees of its cross section, such that the light rays 20 are emitted from the lens in a circular pattern, substantially collimated in each plane extending in the X-direction.

By way of illustration and with reference to FIG. 1D, a schematic side view of the lens 10 is shown, wherein the lens 10 collimates light rays 20 in a vertical plane. In other words, the light rays 20 are refracted by the curved and flat sides 12, 14 of the lens 10, and the light rays 20 are emitted substantially parallel to the X-axis such that the light rays 20 are not spread in the Z-direction. With reference to FIG. 1E, a schematic plan view of the lens 10 is shown, wherein the lens 10 is shown collimating the light rays 20 in a horizontal plane. As such, the light rays 20 are refracted by the curved side 12 of the lens 10, and the light rays 20 are emitted substantially parallel to the X-axis such that the light rays 20 are not spread in the Y-direction.

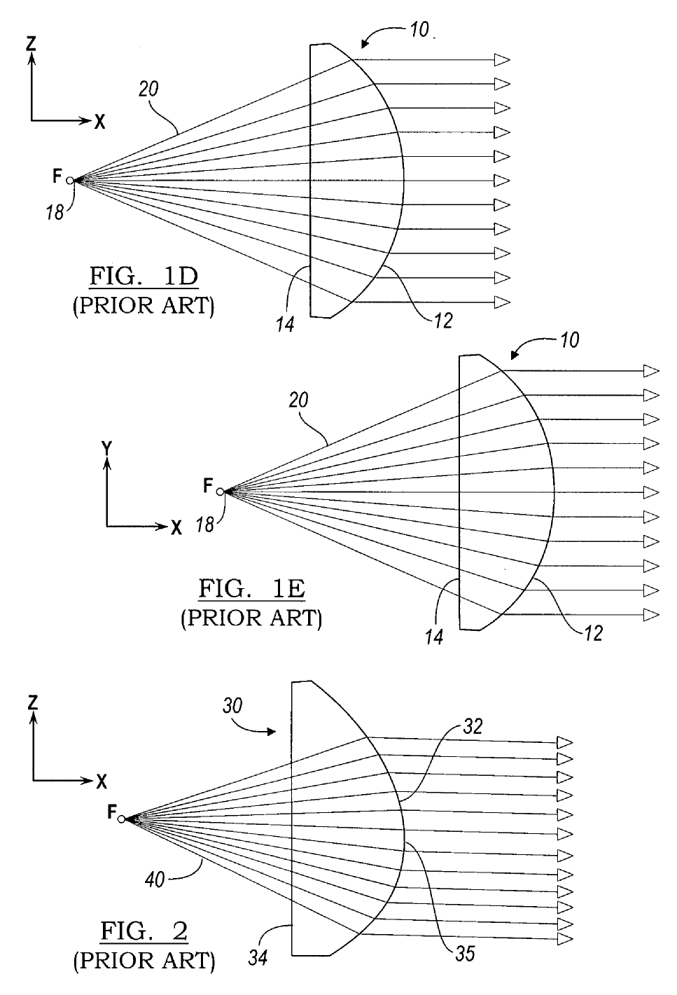

Referring now to FIG. 2, a schematic side view of a free form condenser lens is illustrated at 30. The free form condenser lens 30 is similar to the standard condenser lens 10, but is asymmetric and is constructed by numerical technique. As seen in the figure, the free form condenser lens 30 generally has a cross section similar to that of a standard condenser lens 10, having a curved side 32 disposed opposite to a flat side 34. However, the apex 35 of the curved side 32 is vertically lower than it would be in a standard condenser lens 10. This allows the light rays 40 to be collimated in a vertical plane, but at a lower vertical height than with the standard condenser lens 10. Although the free form condenser lens 30 may slightly spread the light rays 40 vertically or horizontally, it still substantially collimates the light rays 40 in both of these directions.

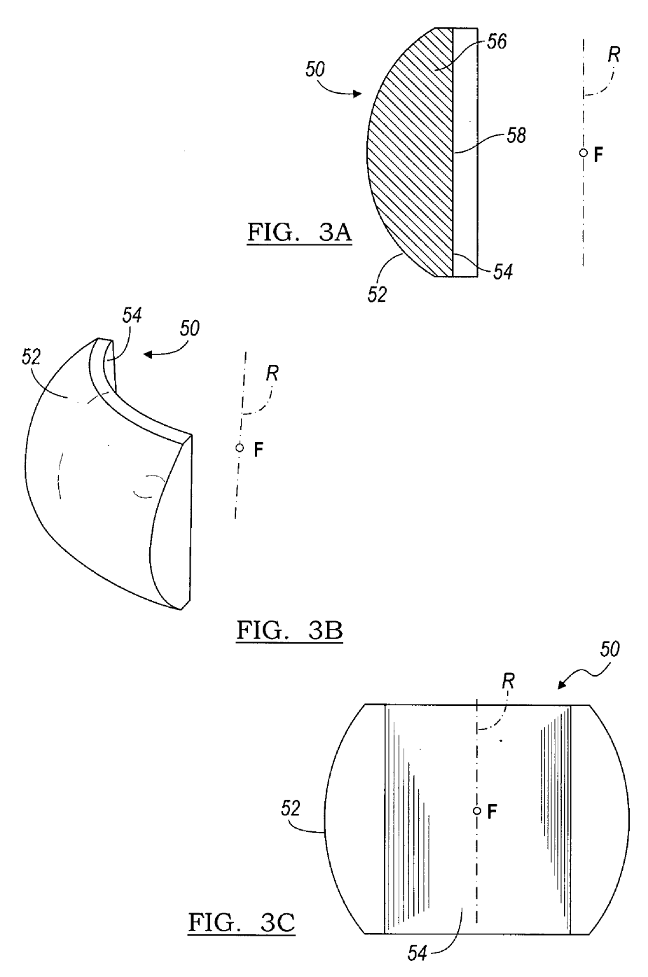

Referring now to FIGS. 3A-3C, a lens embodying the principles of the present invention is illustrated therein and designated at 50. The lens 50 has a body 56 whose cross section defines a curved light emitting face or side 52 disposed opposite of a light receiving face or side 54. In the present embodiment, the vertical cross section of the body 56 of the lens 50 is substantially the same as the vertical cross section of the standard condenser lens 10, namely it is of a plano-convex-shape. It should be noted, however, that the vertical cross section of the body 56 could have other shapes, such as one similar to that of the free form condenser lens 30 previously discussed, or any other suitable shape, without falling beyond the spirit and scope of the present invention. As further discussed below, the horizontal cross section of the body 56 differs from the noted lenses. In particular, the body 56 exhibits a convex-concave shape when viewed in horizontal section.

The curved side 52 of the cross section 56 has a focal point F outside of the lens 50, and an axis of revolution R of the lens 50 extends through the focal point F. The axis of revolution R is also substantially parallel to a straight line 58 defined by the light receiving side 54 of the lens 50 when viewed in vertical section. To form the lens 50, the vertical cross section of the body 56 is rotated around the axis of revolution R so as to form a partial toroidal shape. Because the straight line 58 is rotated around the axis of revolution R, the light receiving face 54 has a concave shape, as best seen in FIG. 3D, that is a portion of a cylinder. As noted above, the light-emitting face 52 is convex in shape.

This partial toroidal shape of the lens 50 is configured to collimate light rays 62 in a vertical plane, while maintaining the original spread of the light rays 62 in a horizontal plane. For example, with reference to FIG. 3D, a schematic plan view of the lens 50 is illustrated. A light source 64 located at the focal point F emits light rays 62, which are directed through the lens 50. In a horizontal plane (the Y-direction), the lens 50 does not collimate the light rays 62. Rather, the lens 50 directs the light rays 62 through the lens 50 along substantially the same paths as their original paths, maintaining a horizontal spread of the light rays 62.

The horizontal beam width from the light source 64 is controlled by the angular extent of the lens 50, which is the angle of revolution of the lens 50 about the axis of revolution R and is preferably between about 30 and 180 degrees, depending on the desired horizontal spread of light rays 62. It is contemplated that the lens 50 could have other angles of revolution, from greater than 0 up to 360 degrees, without falling beyond the spirit and scope of the present invention. The angle of revolution actually used will depend on the particular application, and possibly other design criteria.

With reference to FIG. 3E, a schematic side view of the lens 50 is illustrated. As seen therein, the light rays 62 emanating from the light source 64 are collimated in a vertical plane by virtue of the curved side 52 of the body 56 of the lens 50. The light rays 62 are collimated in the vertical plane, the Z-direction, in substantially the same way as light rays 20, 40 are collimated by the standard and free form condenser lenses 10, 30 previously discussed.

The unique shape of the toroidal lens 50 allows light rays 62 to be collimated in a plane extending through the axis of rotation R, while substantially remaining in their original direction in a plane perpendicular to that axis. It should be understood that the collimating direction need not be the vertical direction from ground as it will be appreciated that the lens 50 can be oriented in various positions relative to ground and that a particular application may require the spread to be in a plane that is not horizontal, but rather in another plane.

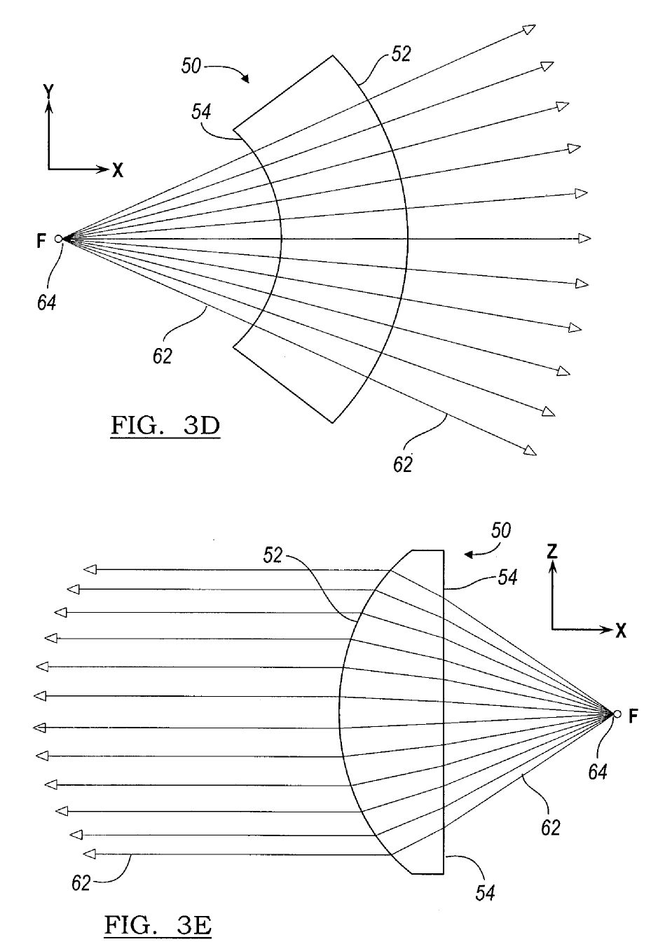

In some applications, it is desirable to spread the light rays 162 emanating from the light source 164 beyond the direction of their original paths. With reference to the schematic plan view of FIG. 4, a lens 150 is provided that achieves such a spreading of the rays 162. The lens 150 of FIG. 4 is identical to that seen in FIGS. 3A-3E except for the light collecting face 54. In the embodiment of FIG. 4, the light collecting face 154 further comprises a plurality of surface irregularities in the form of adjacent concave features, or flute optics 166. It is also contemplated that the surface irregularities could have a variety of other shapes without falling beyond the spirit and scope of the present invention. For example, the surface irregularities could take the form of pillows, prisms, or other surface optics. Furthermore, FIG. 4 shows flute optics 166 being located on the light-collecting face 154 of the lens 150, but it is also contemplated that surface irregularities or optics could be located on a light-emitting face 152 of the lens 150. The flute optics 166 of this embodiment spread the light rays 162 in a horizontal direction, or Y-direction; however, the light rays 162 will remain collimated or nearly collimated in the vertical direction, or Z-direction. As such, the flute optics 166 do not merely maintain the horizontal spread of the light rays 162. Rather, the flute optics 166 are configured to refract the light rays 162 through the lens 150, resulting in the light rays 162 deviating from their original directions, with some of the light rays 162 deviating farther outwardly in a horizontal plane or direction.

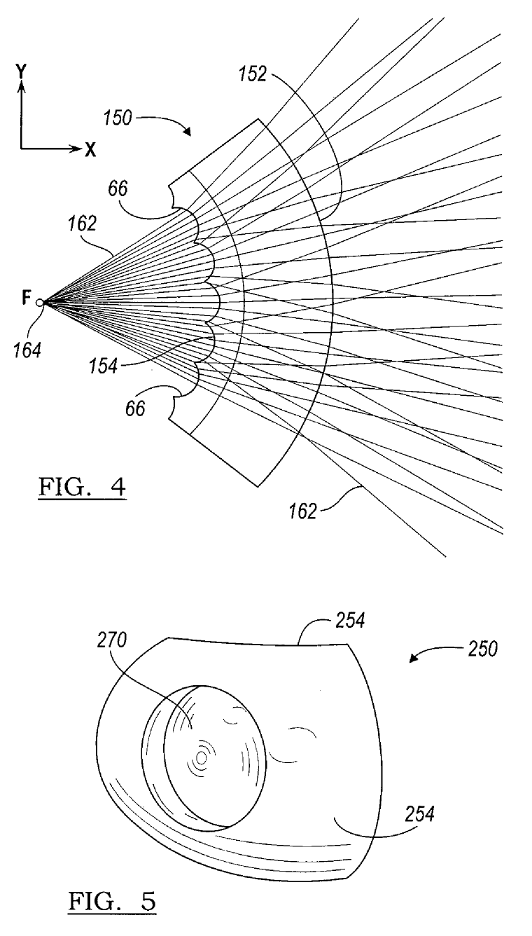

With reference to FIG. 5, a lens 250 having substantially the same construction as the lens 50 of FIGS. 3A-3E is illustrated therein. In this embodiment, the lens 250 has a light-collecting face 254 disposed opposite to a light-emitting face 252. The lens 250 has an integrated collimating lens 270 to increase the beam intensity at the center of the beam. In this embodiment, the integrated collimating lens 270 has a convex curved shape, substantially similar to that of a standard condenser lens 10. However, it is contemplated that the integrated collimating lens 270 can have other shapes, such as that of a free form condenser lens 30. Furthermore, the integrated collimating lens 270 could have surface optics on its light receiving and/or emitting surfaces.

The lenses 50, 150, 250 of the present invention are preferably formed of polymethyl methacrylate (PMMA), commonly known as acrylic, or of polycarbonate (PC), although any suitable optical-grade plastic or glass could be used. The lenses 50, 150, 250 are also preferably used with an LED light source, although it is contemplated that any suitable light source could be used, such as a light bulb.

As a person skilled in the art will readily appreciate, the above description is meant as an illustration of implementation of the principles of this invention. This description is not intended to limit the scope or application of this invention in that the invention is susceptible to modification, variation, and change, without departing from the spirit of this invention, as defined in the following claims.

We claim:

1. A lens for use with a light source, the lens comprising:
a main body having a cross section with a curved side located opposite from a straight side, the curved side defining a focal point outside of the main body, the main body being defined as a partial revolution of the cross section about an axis of revolution that is parallel to the straight side of the cross section and passes through the focal point, wherein a surface of rotation defined by the curved side is a curved surface, and wherein a surface of rotation defined by the straight side is a cylindrical surface, the curved surface collimating light rays in a first plane while allowing for the spreading of the light rays in a second plane.

2. The lens of claim 1, wherein the cross section of the main body is a plano-convex shaped cross section.

3. The lens of claim 1, wherein the main body has a toroidal shape.

4. The lens of claim 1, wherein the first plane is perpendicular to the second plane.

5. The lens of claim 1, wherein the lens is configured to collimate light rays in the first plane while maintaining the original direction of the light rays in the second plane.

6. The lens of claim 1, wherein the curved surface is symmetrical about the focal point.

7. The lens of claim 1, wherein the curved surface is asymmetrical about the focal point.

8. The lens of claim 1, wherein the cylindrical surface further comprises a plurality of surface optics.

9. The lens of claim 8, wherein the surface optics are concave features.

10. The lens of claim 8, wherein the surface optics are concave flute optics.

11. The lens of claim 1, wherein the curved surface further comprises an integrated collimating lens.

12. The lens of claim 11, wherein the integrated collimating lens has a convex surface with a second focal point that is different from the focal point of the curved surface.

13. The lens of claim 1, wherein the cylindrical surface lies closer to the focal point than the curved surface.

14. A lamp assembly comprising:
a light source; and
a lens, the lens having a cross section with a curved side located opposite from a straight side, the curved side defining a focal point outside of the lens, the lens being defined as a partial revolution of the cross section about an axis of revolution that is parallel to the straight side of the cross section and passes through the focal point, wherein a surface of rotation defined by the curved side is a curved surface, and wherein a surface of rotation defined by the straight side is a cylindrical surface, the curved surface collimating light rays in a first plane while allowing for the spreading of the light rays in a second plane.

15. The lamp assembly of claim 14, wherein the light source comprises at least one light-emitting diode.

16. The lamp assembly of claim 14, wherein the cross section of the lens is a plano-convex shaped cross-section.

17. The lamp assembly of claim 14, wherein the lens has a toroidal shape.

18. The lamp assembly of claim 14, wherein the first plane is perpendicular to the second plane.

19. The lamp assembly of claim 14, wherein the lens is configured to collimate light rays in the first plane while maintaining the original direction of the light rays in the second plane.

20. The lamp assembly of claim 14, wherein the cylindrical surface lies closer to the focal point than the curved surface.
